(19) United States
(12) Patent Application Publication
(10) Pub. No.: US 2002/0173866 A1
(43) Pub. Date: Nov. 21, 2002

(54) Digital mp3 audio device

(76) Inventors: Andreas Dangberg, Paderborn (DE); Wolfgang Muller, Paderborn (DE)

Correspondence Address: BELL, BOYD & LLOYD, LLC, P. O. BOX 1135, CHICAGO, IL, 60690-1135, US

(21) Appl. No.: 10/130,399

(22) PCT Filed: Sep. 13, 2001
(86) PCT No.: PCT/DE01/03523

(30) Foreign Application Priority Data
Sep. 14, 2000 (DE) 100 45 557.3

(51) Int. Cl. G06F 17/00

(52) U.S. Cl. 700/94; 704/270; 360/32; 369/63

(57) ABSTRACT

An appliance for recording and playing back audio signals, having a semiconductor memory which stores digital audio signals coded and compressed in a first format, a broadcast radio receiver for digital audio signals coded and compressed in a second format, a controller which is used to store audio signals received by the broadcast radio receiver in the semiconductor memory without recoding, and a playback part which can be used to render the audio signals stored in the semiconductor memory audible.

The invention relates to an appliance for playing back and recording audio signals using semiconductor memories.

The recording of audio signals on magnetic tapes has been known for a long time. Progress in microelectronics has resulted in corresponding players, for example known under the brand name ‘Walkman’ from Sony, having become available generally and inexpensively as pocket appliances. The digitization of audio signals has also created a demand for players for audio media with digital storage. Mention will first of all be made of the ‘compact disc’ and the ‘minidisc’ in this regard. The former uses uncompressed storage and therefore uses an optical storage disc. The ‘minidisc’ uses the lossy compression ATRAC and can therefore use a magnetic storage disc. Hence, for the ‘minidisc’, appliances in pocket format are known which can also record.

The recording of audio signals in digital form poses a problem to the extent that a pocket appliance can accommodate the processing power only with difficulty. For uncompressed storage, no techniques are known which could store for up to an hour with low power consumption in a pocket appliance. This has been implemented to date for the compression method ATRAC only, as indicated, which included this option from the outset.

As another variant, which uses no movable parts, the compression format ‘MPEG2 layer 3 audio’, normally denoted by the abbreviation ‘MP3’, has recently been used. For this, players in pocket format are known which use high capacity semiconductor memories as audio media and can easily play back an audio program of up to an hour. The semiconductor memories used are also used in digital cameras.

However, creation of the audio media has to date always required a fixed appliance. The reason for this is that the compression format MP3 was developed for playback of films, where compatibility and speed during playback take priority. For the production of a film, the necessary coding for the audio signal is a negligible extravagance.

Wireless transmission of audio signals by broadcast radio stations has been known for a long time. The miniaturization of receiving circuits through microelectronics has resulted in a need to accommodate an appropriate receiver for analog audio broadcast radio signals in a matchbox without difficulty. It is therefore not surprising that there are players of the aforementioned type which incorporate a broadcast radio receiver and can be used either to play an audio medium or to receive a radio program.

In this context, appliances are well known in which the broadcast radio program can be recorded on magnetic tape by analog means. Digital recording on ‘compact disc’ has been unsuitable from the outset. However, digitally recording a radio program on ‘minidisc’ can be regarded as less problematical from a technical point of view for a pocket appliance, since pocket appliances with a recording function are known and the incorporation of a broadcast radio receiver is evidently not a problem.

However, there has been no disclosure to date of combining a player for MP3 coded audio signals which uses semiconductor memories as data media with a broadcast radio receiver so that the broadcast radio program can be recorded in MP3 format. This is because real-time MP3 coding of the broadcast radio signal received in analog format requires computers whose power consumption does not allow sufficient operating time for a portable or pocket appliance.

However, an MP3 player is known in which a notepad function stores audio signals recorded by a microphone in a second semiconductor memory. The recording quality and storage time are very limited, however, which is why it is not suitable for recording broadcast radio signals.

It is therefore an object of the invention to specify an appliance which can be used to store radio programs at high quality in semiconductor memories and whose power consumption is nevertheless low enough for a portable appliance.

The invention achieves this object by using a broadcast radio receiver for digitally coded audio signals and storing these digitally coded data directly, i.e. without recoding, in the semiconductor memory.

Broadcast radio with digital uncompressed audio data is known by the abbreviation DSR (Digital Satellite Radio); transmission was stopped a short time ago, however. Broadcast radio with digital lossy audio data is known by the acronyms ADR and DAB. ADR is broadcast exclusively by satellite and is also not intended for terrestrial transmission. By contrast, DAB (Digital Audio Broadcast) is matched to the specific requirements of terrestrial transmission and is already being transmitted in Germany. Further information relating to DAB can be obtained from the European Broadcasting Union, Ancienne Route 17A, CH-1218 Grand-Saconnex. Up-to-date information about this can also be retrieved electronically at http://www.worlddab.org/.

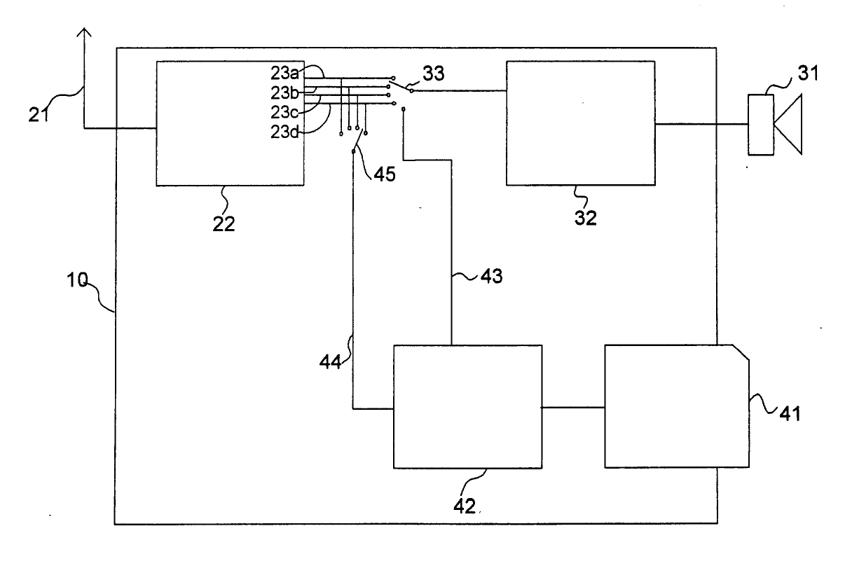

FIG. 1 shows a block diagram of an appliance in accordance with the invention.

The interior of the digital audio appliance 10 contains a receiver 22 for digital broadcast radio, a decoder 32 and a memory controller 42. The receiver 22 is connected to an antenna 21, which in this case is shown outside the appliance but can naturally also be arranged in the interior of the housing. The decoder 32 is connected to a loudspeaker 31, which can naturally also be replaced by an earphone or the like. The memory controller 42 is connected to a digital semiconductor memory 41, for example in the form of a ‘compact flash’ memory card, as is also used in digital cameras. The memory 41 is shown as being replaceable in the drawing.

The receiver 22 is shown with a series of outputs 23a, 23b, 23c and 23d. This is to be understood as a basic illustration which is explained further below. A selector switch 33 makes it possible to select either one output of the memory controller 42 or one of the receiver's outputs 23a to 23c for the decoder 32 and to convert the selected signal into an audible audio signal. It is assumed in this context that, at the same time as the selector switch 33 is set, the decoder 32 is also set to the appropriate format in which the data are output from the source. At all events, in accordance with the invention, the decoder is supplied with a digitally coded audio signal. This does not prevent one development from also involving the incorporation of an analog receiver, and the latter's signal being able to be supplied upstream of the loudspeaker 31 instead of the digital decoded signal.

Accordingly, a recording selector switch 45 is provided which can be used to connect one input of the memory controller 42 to one of the outputs of the receiver. The memory controller, when activated, stores the digital data arriving via the connection 44 in the memory card 41 without further processing.

The figure does not show a global controller, which comprises input means (not shown) which the user of the appliance can use to control the appliance. Such controllers based on a microcontroller or customer-specific digital circuits are known generally. The task of the global controller is to set the changeover switches 33 and 45, to tune the receiver 22, to control the decoder 32 and to control the memory controller 42. The latter needs control for reading and writing, in particular. Customary memory cards are organized in a comparable way to a file system, which means that the memory controller needs to be notified of which file is being read and which file is being written to. In this context, it is assumed that competing reading and writing are available in order to implement the preferred embodiment.

The receiver 22 has been shown in FIG. 1 with, by way of example, four outputs 23a to 23d. This is because digitally coded broadcast radio, particularly also DAB, involves the use of a connection which provides a much higher bandwidth than is required for a single program. The various programs are transmitted using multiplexing and are split in the receiver by means of a demultiplexer. It is therefore no complex matter in digital radio broadcasting to provide a plurality of audio channels at the same time.

Accordingly, the invention provides a simple way of simultaneously listening to one broadcast radio program and recording another, or of listening to a stored item and recording a broadcast radio program. If the memory controller 42, the changeover switch 45 and the connection 44 are of appropriate design, it is even possible to record a plurality of programs at the same time, provided that the bandwidth of the memory 41 is not exceeded. If appropriate, the switch 45, which is preferably a second demultiplexer for themultiplex signal, is incorporated into the recording controller.

Accordingly, the controller (not shown) is provided with a clock, so that, by way of example, a piece of music from one radio station can be recorded and also the news is always recorded on the hour. Digital controllers also allow the news or another program which is being recorded to be heard from the start, and then naturally with an appropriate time shift. Appliances known to date merely allow the program which is being recorded to be heard at the particular point being transmitted, or else to be heard from the beginning only after recording has ended.

The invention now makes it possible also to use portable appliances similar to a ‘walkman’ or ‘discman’ to listen to stored digital audio signals, to listen to digital radio programs and to record a digital radio program at the same time, which can even be done at the same time as listening to another radio program and in which case it is actually possible to start playback during recording.

1. An appliance for recording and playing back audio signals, having:
a semiconductor memory which stores a plurality of streams of coded and compressed digital audio signals independently of one another,
a broadcast radio receiver for coded and compressed audio signals,
a controller which is used to store coded and compressed digital audio signals received by the broadcast radio receiver without recording into a stream in the semiconductor memory,
a playback part with [lacuna] a stream of coded and compressed digital audio signals which is stored in the semiconductor memory or is received by the broadcast radio receiver is rendered audible.

2. The appliance as claimed in claim 1, where the playback part reproduces streams even if their storage of these streams is not yet complete.

3. The appliance as claimed in claim 1 or 2, where the broadcast radio receiver provides a plurality of streams of coded and compressed audio signals, and the controller stores more than one of these streams in the semiconductor memory at the same time.

4. The appliance as claimed in one of the preceding claims, where the semiconductor memory provided is replaceable modules.

5. The appliance as claimed in claim 4, where, for each stream, an indicator for the compression format is stored, and the playback part uses this indicator to select one of a plurality of decompressors when the stream in question is rendered audible.
